(19) United States
(12) Patent Application Publication
(10) Pub. No.: US 2011/0093673 A1
(43) Pub. Date: Apr. 21, 2011

(54) METHOD OF MANAGING A MEMORY OF A TERMINAL

(75) Inventor: David Wright, Courbevoie (FR)

(73) Assignee: AVANQUEST SOFTWARE, LA GARENNE COLOMBES (FR)

(21) Appl. No.: 12/448,982

(22) PCT Filed: Jan. 16, 2008
(86) PCT No.: PCT/FR2008/050073

§ 371 Date: Dec. 3, 2010

(30) Foreign Application Priority Data
Jan. 17, 2007 (FR) 0752729

(51) Int. Cl. G06F 12/00

(52) U.S. Cl. 711/162; 711/E12.103

(57) ABSTRACT

The invention provides a method of managing a memory of a terminal, wherein a substitute file is substituted in the memory of the terminal for at least one predetermined file, which file is previously backed-up in a member other than the terminal, the substitute file having content that is obtained at least in part from the predetermined file.

The present invention relates to a method of managing a memory of a terminal.

More particularly, the invention relates to a multimedia mobile terminal suitable for reading digital files such as photographs, videos, or audio files. The mobile terminal includes a memory for storing digital files.

When the multimedia functions of the mobile terminal are used, the content of the memory of the terminal can vary, and in particular it can grow. For example, when the terminal includes a digital camera, new photographs may be stored in its memory.

In the mobile terminal of the prior art, the greater the number of files stored in the memory, the longer and the more difficult it is to find a given file.

A particular object of the invention is to solve that drawback.

To this end, the invention provides a method of managing a memory of a terminal, wherein a substitute file in substituted in the memory of the terminal for at least one predetermined file, which file is previously backed-up in a member other than the terminal, the substitute file having content that is obtained at least in part from the predetermined file.

Advantageously, the content of the substitute file is a function of the number and/or the types of the files contained in the memory before implementing the method. Thus, whatever the occupation state of the memory of the terminal, the way the memory is arranged can be optimized in application of various predefined criteria, for example so that searching for a given file is made simple and fast. Although the content of the memory of the terminal is modified, the initial content of the memory remains accessible on the member other than the terminal.

A management method of the invention may also include one or more of the following characteristics.

The terminal is a mobile terminal, e.g. a mobile telephone or a personal digital assistant.

The substitute file presents a size that is smaller than the size of the predetermined file. By means of this characteristic, the substitution step enables the occupation level of the memory to be decreased while conserving access to the predetermined file, which is backed-up in the member. This is particularly advantageous when the method is implemented to manage the memory of a mobile terminal. The storage capacity of the memory of a mobile terminal is generally limited, and it commonly happens that this memory becomes saturated, thereby presenting the drawback of preventing any more files being added.

The substitute file comprises a degraded copy of the predetermined file, i.e. a copy that is of lower quality, e.g. of lower resolution or lower coding rate. By reducing the resolution of an image or the coding rate of an audio file, it is possible to reduce its size in significant manner. This makes it possible to adapt the quality of the file stored in the memory to the playback or display capacities of the terminal, which capacities are sometimes limited. For example, if the predetermined file is a digital photograph taken by the camera of the mobile terminal, the photograph comprises several millions of pixels in order to enable a quality print to be made. Nevertheless, because the screen of the mobile terminal is small, it is possible for said high resolution photograph to be substituted by a low resolution substitute photograph without hindering the user. The high resolution photograph remains accessible on the member.

A plurality of predetermined files may be substituted by a single substitute file. Another way of optimizing the occupation of the memory consists in replacing a plurality of predetermined files by a single substitute file. For example, all predetermined files from a given year may be grouped together within a single substitute file.

The single substitute file comprises any one of the predetermined files that have been substituted or a degraded copy of said any one file.

The member is a server accessible from the terminal, at least under predefined conditions.

The method includes a preliminary step of synchronizing the terminal with the member to update an image of the memory of the mobile terminal that is conserved in the member. By means of this synchronization, the member conserves the image of a content of the memory of the terminal at the time of the most recent synchronization. This image makes it possible in particular for the member to know the distribution between the predetermined files and the substitute files in the memory of the terminal. During the preliminary synchronization step, the member compares the state of the memory of the terminal at the time of the synchronization with the state of said memory at the time of the preceding synchronization. Thus, this synchronization step may be fast and simple since the member updates only those files that have changed between two synchronizations.

The member responds to the image of the memory of the terminal to determine a set of predetermined files that are to be substituted by at least one substitute file. Thus, because the member knows accurately the occupation state of the memory of the mobile terminal, it is capable of determining an optimal arrangement of said memory, making it possible to reduce the occupation of the memory of the terminal. That thus makes it possible to use the processor of the member, which processor is generally faster than the processor of the terminal.

The substitute file is the result of the member converting the backed-up file, with the substitute file then being transmitted to the terminal which substitutes it for the predetermined file. As before, it is the member that undertakes conversion of the predetermined file into a substitute file, thereby making it possible to limit the use of the processor of the terminal.

The substitute file is substituted for the predetermined file when a predefined criterion is satisfied. In particular this substitution may be implemented without intervention on the part of the user of the terminal.

The predefined criterion comprises an occupation level of the memory of the terminal, e.g. a percentage utilization of the memory or a size of utilization of the memory. Thus, when the memory comes close to saturation, the method is implemented so as to reduce the occupation level of the memory.

The predefined criterion comprises a date associated with the predetermined file, e.g. a file creation date or a file access date. The use of a date associated with the predetermined file as the predefined criterion is particularly advantageous since that makes it possible, for example, to conserve intact the files that have been most recently created or consulted from the terminal, and on the contrary to compact files that are very old or that are rarely consulted from the terminal.

The invention also provides a member for managing a memory of a terminal, the member including means for backing-up at least one predefined file contained in the memory of the terminal, means for converting the predetermined file into a substitute file having content that is obtained at least in part from the predetermined file, and means for causing the substitute file to be substituted in the memory of the terminal for the predetermined file.

The invention also provides a terminal including a memory and means for transmitting a predetermined file of the memory to a member other than the terminal, the terminal including means for converting the predetermined file into a substitute file, and means for causing the substitute file to be substituted in the memory for the predetermined file.

The invention also provides an assembly comprising a terminal and a member, either one of them being as defined above.

The invention also provides a computer program for execution by a computer, the program including instructions for executing a method as defined above.

The invention also provides a data recording medium, including a computer program as defined above.

The invention also provides a signal including a substitute file resulting from the conversion step of a method as defined above.

The invention also provides a recording medium including a substitute file involved in implementing a method as defined above.

The invention can be better understood on reading the following description given purely by way of example and made with reference to the accompanying figures, in which:

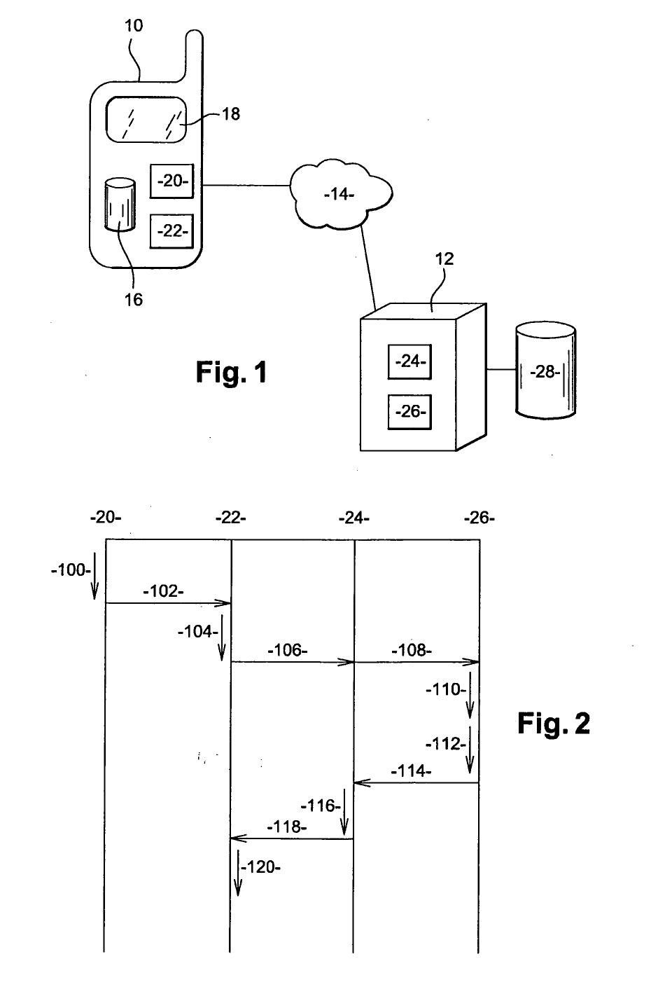

FIG. 1 is a diagram of a terminal and a member adapted to implementing a method of the invention; and

FIG. 2 is a diagram of the steps of a management method of the invention.

FIG. 1 shows a terminal 10 connected to a member 12 other than the terminal 10 via a network 14. Specifically, the terminal 10 is a mobile telephone, the member 12 is a server, and the network 14 is a data transmission network such as the Internet. The mobile telephone 10 is suitable for exchanging data with the server 12 via the network 14.

The telephone 10 includes a memory 16 for storing multimedia data such as audio, video, or photo data. To acquire such multimedia data, the telephone 10 may be fitted with means for making a USB (universal serial bus) type connection with a computer, or with a camera that enables digital photographs to be taken. To enable multimedia data to be managed and viewed, the telephone 10 includes a screen 18.

The telephone 10 also includes a monitoring agent 20 for monitoring the state of occupation of the memory 16 and a synchronization client 22 for synchronizing with a synchronization module 24 of the remote server 12. This synchronization of the memory 16 of the telephone 10 with the server 12 makes use, for example, of the open mobile alliance data synchronization (OMA DS) protocol that is known in the state of the art.

In addition to the synchronization module 24, the server 12 includes an application 26 for managing the memory 16 of the telephone 10. The server 12 is also connected to data storage means 28.

By virtue of the synchronization means 22 and 24, the server 12 is suitable for storing in the storage means 28 and for updating an image in the memory 16 of the telephone 10. Naturally, the server 12 may manage a plurality of terminals 10 simultaneously, each terminal 10 being identified in unique manner by an international mobile equipment identity (IMEI) identifier.

While the mobile telephone 10 is in use, digital files, such as new photographs, may be added to its memory 16. To avoid saturating the memory 16, it is proposed to optimize the occupation of this memory by means of a management method of the invention.

This method of managing the memory 16 of the telephone 10 consists in causing a substitute file to be substituted in the memory 16 of the telephone 10, for at least one predetermined file, which predetermined file is previously backed-up in the storage means 28, with the substitute file having content that is obtained at least in part from the predetermined file. Preferably, the size of the substitute file is smaller than the size of the predetermined file.

By way of example, consideration is given to a predetermined file that is a digital photograph.

In a first variant of the invention, a degraded copy of the photograph is substituted in the memory 16 for the digital photograph that was initially contained in the memory 16. The term “degraded copy” is used to mean a copy of lower quality, i.e. a copy of lower resolution, and preferably of resolution that is adapted to the screen 18 of the telephone 10. This low resolution copy has a file size that is smaller than that of the original photograph, thus making it possible to reduce the occupation of the memory 16.

In a second variant, it is proposed to cause a single substitute file to be substituted for a plurality of predetermined files. For example, it can be decided to group together a plurality of digital photographs that are associated with a common theme, and to replace them with a single substitute photograph that is characteristic of the group. For example, this single substitute photograph may be any one of the photographs that have been grouped together, or it may be constituted by a mosaic of the various photographs.

The common theme of the various grouped-together photographs may be a period of time. For example, all photographs of the same week or of the same month or of the same year can be grouped together. Naturally, the substitute file used to represent all of the photographs having the same theme may itself be a degraded photograph of resolution that is adapted to the parameters of the screen 18 of the telephone 10.

Prior to making this substitution, it is essential for the original file that was originally present in the memory 16 of the telephone 10 to be backed-up in the storage means 28 of the server 12.

As mentioned above, one of the objects of this reorganization of the memory 16 of the telephone 10 is to reduce the occupation of said memory. Thus, it is advantageous for the management method of the invention to be triggered automatically when the level of occupation of the memory of the terminal reaches a predefined threshold. For example, as the camera of the telephone 10 is used, the memory 16 fills progressively, and once the filling level of the memory reaches the predetermined threshold, the management method of the invention is implemented so as to reduce the occupation level of the memory 16. By means of the invention, any risk of the memory 16 saturating is reduced, since memory space is released progressively as the memory is filled.

Naturally, this management method may also be triggered manually or at specified times.

The management method of the invention is described in greater detail below with reference to FIG. 2.

During a first step 100, the monitoring agent 20 for monitoring the memory 16 of the telephone 10 runs as a background task in order to determine how much memory is available.

When the monitoring agent 20 detects that the maximum occupation threshold of the memory 16 has been exceeded, it acts during a step 102 to issue a synchronization request that is sent to the synchronization client 22.

During a step 104, the client 22 draws up a list of multimedia data that has been acquired since the most recent synchronization. By way of example, this multimedia data may be the latest digital photographs to have been taken by the camera of the telephone 10.

During a step 106, the client 22 sends a synchronization request to the synchronization module 24 of the server 12. This synchronization request comprises in particular the new files that have been added to the memory 16 of the telephone 10 since the most recent synchronization. These new files are to be backed-up in the storage means 28 of the server 12.

During a following step 108, the synchronization module 24 transmits the request to reorganize the memory 16 to the management application 26 for managing the memory 16.

During a step 110, the application 26 transmits to the storage means 28 those files that have recently been added to the memory 16 of the telephone 10, and it updates the image of the memory 16 that it conserves in memory. This image enables the application 26 to identify those files that are actually present in the memory of the terminal 10 and also the format in which the files are stored. In particular, if the files have been substituted by substitute files, then the application 26 knows the format of the substitute files.

During a step 112, the application 26 responds to the image of the memory 16 of the terminal 10 to determine a set of files that are to be substituted by at least one substitute file. In other words, the application 26 defines a reorganization of the memory 16 that enables the occupation level of the memory to drop back below the predetermined threshold. In particular, the application 26 determines which files in the memory 16 are to be replaced by substitute files of smaller size.

It is possible to specify reorganization rules to be used by the application 26. For example, it may be decided that the application 26 begins by replacing all multimedia files by degraded representations thereof. Subsequently, if that modification does not enable the occupation of the memory 16 to be reduced sufficiently, the application 26 should make year groups for all of the files belonging to years before the current year. If that is still not sufficient, then the application 26 may make month groups for all of the files of the present year with the exception of those for the current month. Thereafter it is possible to continue grouping files together in week groups or day groups. Naturally, there may be certain exceptions in order to avoid files that are consulted frequently being replaced by substitute files.

Once this memory reorganization has been determined by the application 26, the application transmits its results to the synchronization module 24 in a step 114.

During a step 116, the module 24 applies the modifications determined by the application 26 to the digital files stored in the means 28. Alternatively, the modifications may be applied by the application 26.

Finally, during a step 118, the module 24 transmits the substitute files to the client 22 so that they can take the place of the files originally present in the memory 16.

During a step 120, the synchronization client 22 applies these modifications to the memory 16.

When the computation capability of the telephone 10 is sufficient, it is possible to perform the transformation of the way in which the multimedia file is represented directly in the telephone rather than in the server 12, in order to avoid transferring the substitute files during step 118.

After the management method of the invention has been implemented, some of the files stored in the memory 16 of the telephone 10 are substitute files, with the original files being backed-up in the storage means 28 of the server 12. Nevertheless, these original files continue to be accessible from the telephone 10. For example, when viewing a photograph, it remains possible to zoom in order to see certain details more clearly. The effect of zooming is to download the original multimedia file from the server 12. When the user views a group of a plurality of multimedia files, e.g. a year group of files, and the user decides to zoom into that group, then the zoom has the effect of downloading potential groups of smaller granularity, e.g. month groups.

It is also possible to delete certain files from the memory 16 of the telephone 10. If the deleted files are substitute files, then the original files stored in the storage means 28 of the server 12 will also be deleted during the next synchronization.

Provision can be made for substitute files that are in the form of groups (or mosaics), themselves to be replaced sooner or later by a single common substitute file in the form of a group, with each of the grouped-together elements corresponding to one of the original group files. This process may be continued to build up a plurality of successive grouping levels. Thus, a group file refers to a plurality of group files of lower level, which in turn refer to group files of still lower level, and so on.

The description above relating to photograph files can be used with video files. By way of example, provision can be made to replace each video file by a photo file corresponding to a particular image of the video and/or representing the video. These images may subsequently be grouped together as described above.

It is also possible to replace a video file by another video file of shorter duration, e.g. corresponding to an extract of the first file or at lower resolution. A file of video group may replace a set of video files, this group file being made up of extracts from the original files.

An audio file may be replaced by a file at lower resolution and/or by an extract from the original file.

It is also possible to replace an audio file by an image file and to make groups of such files.

These two possibilities, extracts or groups, may be combined, regardless of whether the original files are audio files or video files.

The invention is also applicable to office files as generated for example by a word processor, a spread sheet, . . . .

The terminal may be a fixed or a mobile computer. The terminal is preferably provided with wireless communications means that support Internet protocol (IP).

1. A method of managing a memory of a terminal wherein a substitute file is substituted in the memory of the terminal for at least one predetermined file, which file is previously backed-up in a member other than the terminal, the substitute file having content that is obtained at least in part from the predetermined file.

2. A method according to claim 1, wherein the terminal is a mobile terminal.

3. A method according to claim 1, wherein the substitute file presents a size smaller than the predetermined file.

4. A method according to claim 1, wherein a single substitute file takes the place of a plurality of predetermined files.

5. A method according to claim 4, wherein the single substitute file comprises any one of the predetermined files that have been substituted or a degraded copy of said any one file.

6. A method according to claim 1, wherein the member is a server accessible from the terminal, at least under predefined conditions.

7. A method according to claim 1, including a preliminary step of synchronizing the terminal with the member to update an image of the memory of the mobile terminal that is conserved in the member.

8. A method according to claim 7, wherein the member responds to the image of the memory of the terminal to determine a set of predetermined files that are to be substituted by at least one substitute file.

9. A method according to claim 1, wherein the substitute file is the result of the member converting the backed-up file, with the substitute file then being transmitted to the terminal which substitutes it for the predetermined file.

10. A method according to claim 1, wherein the substitute file is substituted for the predetermined file when a predefined criterion is satisfied.

11. A method according to claim 10, wherein the predefined criterion comprises an occupation level of the memory of the terminal, e.g. a percentage utilization of the memory or a size of utilization of the memory.

12. A method according to claim 9, wherein the predefined criterion comprises a date associated with the predetermined file, e.g. a file creation date or a file access date.

13. A member for managing a memory of a terminal, the member including means for backing-up at least one predefined file contained in the memory of the terminal, means for converting the predetermined file into a substitute file having content that is obtained at least in part from the predetermined file, and means for causing the substitute file to be substituted in the memory of the terminal for the predetermined file.

14. A terminal including a memory and means for transmitting a predetermined file of the memory to a member other than the terminal, wherein the terminal includes means for converting the predetermined file into a substitute file, and means for causing the substitute file to be substituted in the memory for the predetermined file.

15. An assembly comprising a terminal and a member, wherein one or other of the member and the terminal is in accordance respectively with claim 13.

16. A computer program to be executed by a computer, wherein the program includes instructions for executing a method according to claim 1.

17. A data recording medium, including a computer program according to claim 16.

18. A signal, telephone in that it includes a substitute file resulting from the conversion step of a method according to claim 9.

19. A recording medium including a substitute file involved in implementing a method in accordance with claim 1.

20. A method according to claim 2, wherein the substitute file presents a size smaller than the predetermined file.
